(19) United States
(12) Patent Application Publication
(10) Pub. No.: US 2023/0166419 A1
(43) Pub. Date: Jun. 1, 2023

(54) RAZOR CARTRIDGE

(71) Applicant: DORCO CO., LTD., Seoul (KR)

(72) Inventors: Seung Min SONG, Seoul (KR); Young Jin LEE, Seoul (KR); Sung Hee SON, Seoul (KR); Sang Hun PARK, Seoul (KR)

(21) Appl. No.: 18/058,617

(22) Filed: Nov. 23, 2022

(30) Foreign Application Priority Data
Nov. 30, 2021 (KR) 10-2021-0168710

(51) Int. Cl. B26B 21/40; B26B 21/22

(52) U.S. Cl. CPC B26B 21/4012; B26B 21/22; B26B 21/443

(57) ABSTRACT

Provided is a razor cartridge including: at least one razor blade having a cutting edge formed therein; a blade housing accommodating the at least one razor blade in a longitudinal direction; and a housing cover comprising a razor blade window and a window frame, the razor blade window through which at least a portion of the cutting edge is exposed, and the window frame which is formed to surround at least a portion of the razor blade window and detachably coupled to the blade housing. At least one of the blade housing and the housing cover includes a detachment part for separating at least a portion of the window frame from the housing cover by an external force.

### CROSS REFERENCE TO RELATED APPLICATION

This application claims the benefit of Korean Patent Application No. 10-2021-0168710 filed on Nov. 30, 2021, the contents of which are all hereby incorporated by reference herein in their entirety.

### BACKGROUND OF THE DISCLOSURE

### Field of the Disclosure

The present disclosure relates to a razor cartridge, and more particularly, to a razor cartridge in which a razor blade is accommodated.

### Related Art

In general, a razor is a product for shaving body hair such as facial hair, mustache, beard, and the like, and the razor includes a razor cartridge provided with a handle for gripping and a razor blade for shaving in contact with the skin.

The razor includes a replaceable razor in which the razor cartridge can be replaced, and a disposable razor in which the razor cartridge cannot be replaced.

A razor cartridge is composed of a razor blade, a lubricating band, a housing, etc. In general, the components of the razor cartridge are made of different materials: for example, the housing is made of plastic, the razor blade is made of steel, and the like,

The razor cartridge cannot be easily disassembled by a user for the safety of the user, and the user may be easily injured by the razor during the disassembly process. Therefore, when disposing of the razor cartridge, it is difficult to separate and discharge the razor cartridge according to materials.

### SUMMARY

The present disclosure provides a razor cartridge capable of separation and discharge of components, and a razor blade separating device for separating a razor blade from the razor cartridge.

It should be noted that objects of the present disclosure are not limited to the above-mentioned object, and other objects of the present disclosure will be apparent to those skilled in the art from the following descriptions.

In an aspect, there is provided a razor cartridge including: at least one razor blade having a cutting edge formed therein; a blade housing accommodating the at least one razor blade in a longitudinal direction; and a housing cover comprising a razor blade window and a window frame, the razor blade window through which at least a portion of the cutting edge is exposed, and the window frame which is formed to surround at least a portion of the razor blade window and detachably coupled to the blade housing. At least one of the blade housing and the housing cover includes a detachment part for separating at least a portion of the window frame from the housing cover by an external force.

Other specific details of the present disclosure are included in the detailed description and drawings.

According to the embodiments of the present disclosure, at least following effect can be achieved:

The razor cartridge may be safely and easily disassembled by a user.

Since components of the razor cartridge are allowed to be separated according to materials thereof, it is possible to sort recyclable materials when disposing of the razor cartridge.

The razor blade separator allows the user to easily remove the razor blade without touching the razor blade.

It should be noted that effects of the present disclosure are not limited to those described above and other effects of the present disclosure are included following descriptions.

### BRIEF DESCRIPTION OF THE DRAWINGS

FIG. 1 is a perspective view showing a razor according to an embodiment of the present disclosure.

FIG. 2 is a perspective view showing a state in which a razor cartridge and the handle are separated from the razor shown in FIG. 1.

FIG. 3 is a perspective view showing a rear side of a razor cartridge according to an embodiment of the present disclosure.

FIG. 4 is an exploded perspective view of a razor cartridge according to an embodiment of the present disclosure.

FIG. 5 is a cross-sectional perspective view showing a cross-section taken along line A-A shown in FIG. 3.

FIG. 6 is a cross-sectional perspective view showing a cross-section taken along line B-B shown in FIG. 3.

FIG. 7 is a cross-sectional perspective view showing a cross-section taken along line C-C shown in FIG. 3.

FIG. 8 is a perspective view showing a razor blade separating device according to an embodiment of the present disclosure.

FIG. 9 is a perspective view showing the razor blade separating device shown in FIG. 8, which is in an open state;

FIG. 10 is a cross-sectional perspective view showing the razor blade separating device shown in FIG. 8 with a cover open.

FIG. 11 is an exploded perspective view of the razor blade separating device shown in FIG. 8.

FIGS. 12, 13, 14, 15, 16, and 17 are views schematically showing a series of operations for explaining a method of separating a razor blade using a razor blade separating device according to an embodiment of the present disclosure.

### DESCRIPTION OF EXEMPLARY EMBODIMENTS

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the present disclosure to those skilled in the art, and the present disclosure will only be defined by the appended claims. Like reference numerals refer to like elements throughout the specification.

In addition, embodiments herein will be described with reference to cross-sectional views and/or schematic views, which are ideal exemplary views of the present disclosure. Therefore, the form of an exemplary view may be deformed due to a manufacturing technique and/or an allowable error. In addition, in each drawing of the present disclosure, each element may have been somewhat enlarged or reduced in consideration of convenience of description. Like reference numerals refer to like elements throughout the specification.

Also, in describing the components of the present disclosure, there may be terms used like the first, second, A, B, (i), (ii), (a), and (b). These are solely for the purpose of differentiating one component from the other but not to imply or suggest the substances, order or sequence of the components. In the specification, if a component were described as ‘connected’, ‘coupled’, or ‘linked’ to another component, it may mean the components are not only directly ‘connected’, ‘coupled’, or ‘linked’ but also are indirectly ‘connected’, ‘coupled’, or ‘linked’ via a third component.

Hereinafter, the present disclosure will be described with reference to the drawings for explaining a razor according to an embodiment of the present disclosure.

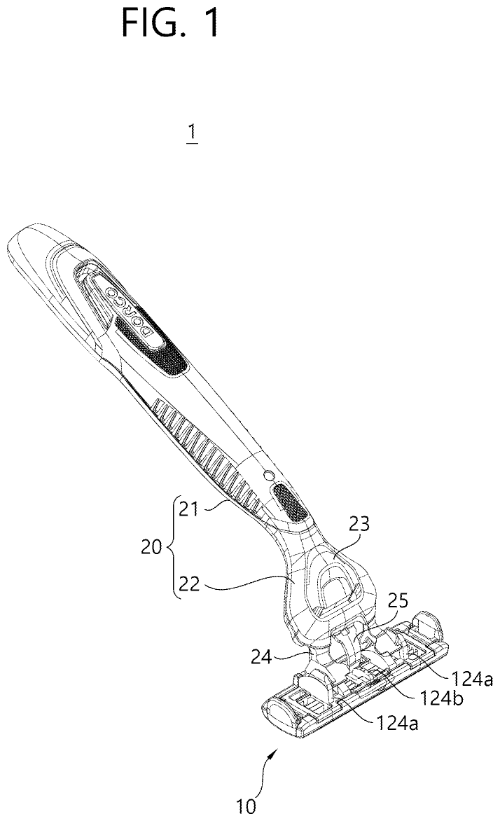

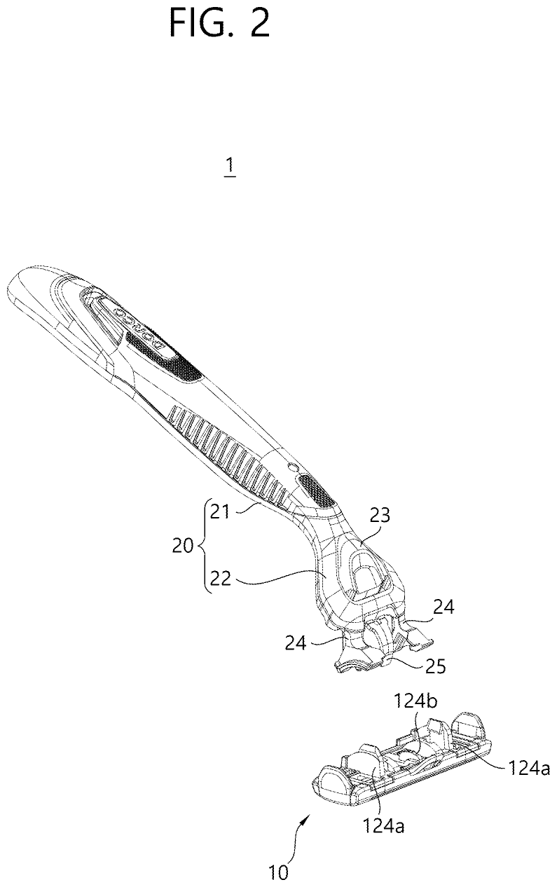

FIG. 1 is a perspective view showing a razor 1 according to an embodiment of the present disclosure, and FIG. 2 is a perspective view showing a state in which a razor cartridge 10 and a handle 20 are separated from the razor 1 shown in FIG. 1.

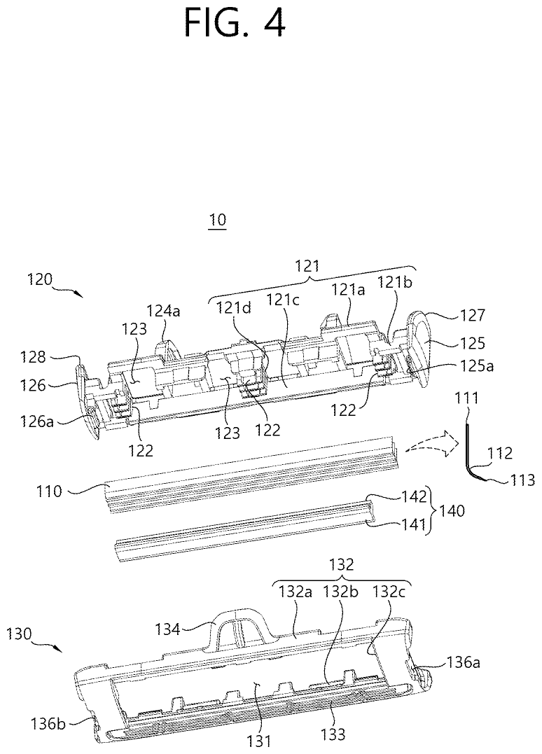

Referring to FIGS. 1 and 2, the razor according to an embodiment includes the razor cartridge 10 provided with a plurality of razor blades 110 (see FIG. 4) and the handle 20 to which the razor cartridge 10 rotatably is coupled.

The handle 20 includes a handle body 21 and a handle head 22.

The handle body 21 is a part to be gripped by a user of the razor 1. The handle head 22 is provided at one end of the handle body 21, and may rotatably support the coupled razor cartridge 10. The handle head 22 may be detachably coupled to the razor cartridge 10, but may be coupled to the razor cartridge 10 in a way to make it difficult to separate therefrom.

The handle head 22 may include an operation part 23, a connection part 24, and an elastic support part 25.

The operation part 23 is a portion of the razor 1 to be operated by the user, and the operation part 23 is connected to the connection part 24 located at one end of the handle head 22 to be driven synchronously with the connection part 24.

The connection part 24 is a portion to be connected to the razor cartridge 10, and as the user operates the operation part 23, the connection part 24 may be operated to be disconnected from the razor cartridge 10.

However, the handle head 22 of the present disclosure does not necessarily include the operation part 23. For example, for the purpose of less use of materials, light weight, recycling, or the like, the handle head 22 of the present disclosure may not include the operation part 23. In this case, the entire handle 20 may be formed of a recyclable material, for example, plastic, and the connection part 24 may be coupled to the razor cartridge 10 so as not to be separated.

While being connected to the razor cartridge 10, the connection part 24 rotatably supports the razor cartridge 10. The connection part 24 may be configured to rotatably support the razor cartridge 10 within a certain angular range with respect to a fixed shaft or a shaft that moves within a predetermined range.

The elastic support part 25 is a portion to elastically support the razor cartridge 10 coupled to the connection part 24, and the elastic support part 25 elastically deforms depending on rotation of the razor cartridge 10 during shaving and elastically supports the razor cartridge 10. Due to the elastic support 25, the razor cartridge 10 is able to return to a predetermined home position when no external force is applied.

For example, referring to FIGS. 1 and 2, the elastic support part 25 is configured to keep in contact with a contact surface 124b exposed on the rear side of the razor cartridge 10, and as the razor cartridge 10 is rotated while being connected to the connection part 24, the elastic support part 25 may be elastically deformed in a state in contact with the contact surface 124b. The elastic support part 25 may be positioned between a pair of connection parts 24, and the contact surface 124b may be positioned between a pair of handle coupling parts 124a.

Hereinafter, the razor cartridge 10 according to an embodiment of the present disclosure will be described in more detail.

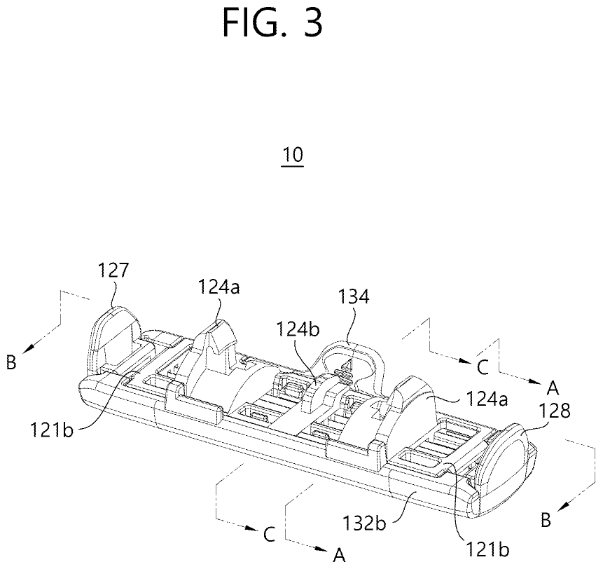

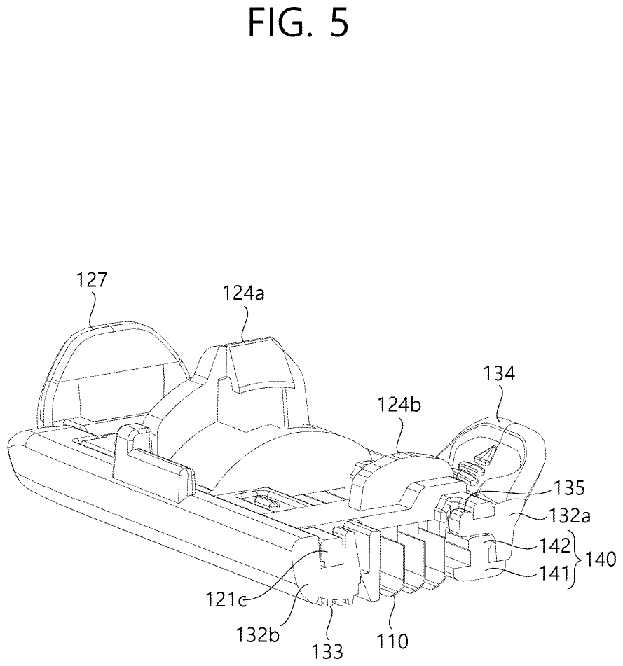

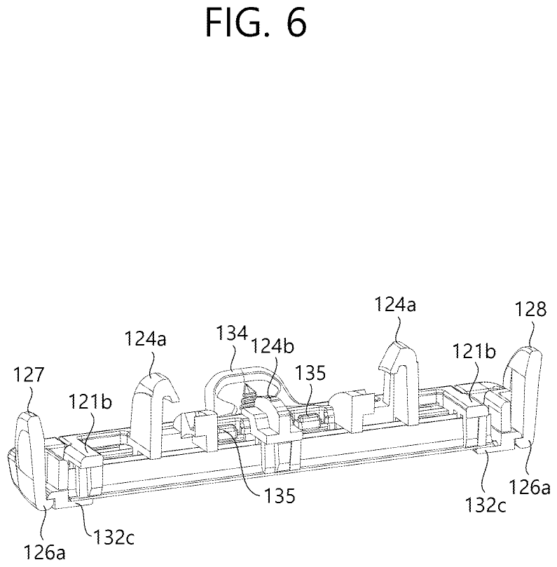

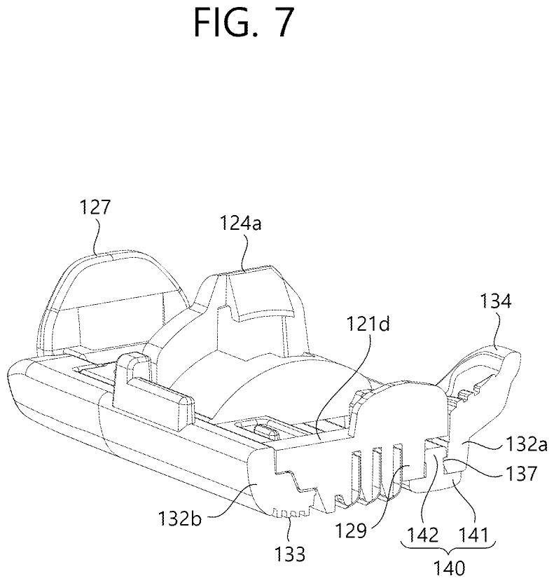

FIG. 3 is a perspective view showing a rear side of the razor cartridge 10 according to an embodiment of the present disclosure, FIG. 4 is an exploded perspective view of the razor cartridge 10 according to an embodiment of the present disclosure, and FIG. 5 is a cross-sectional perspective view showing a cross-section taken along line A-A shown in FIG. 3, and FIG. 6 is a cross-sectional perspective view taken along line B-B shown in FIG. 3, and FIG. 7 is a cross-sectional perspective view taken along line C-C shown in FIG. 7.

Referring to FIGS. 3 to 7, the razor cartridge 10 according to an embodiment may include at least one razor blade 110, a blade housing 120, a housing cover 130, and a shaving auxiliary member 140.

At least one of the razor blade 110, the blade housing 120, the housing cover 130, and the shaving auxiliary member 140 may be manufactured based on a different material. For example, a razor blade 110 may be manufactured based on a steel-based material, the blade housing 120 and the housing cover 130 may be manufactured based on a plastic-based material, and the shaving auxiliary member 140 may be manufactured based on a material different from that of at least one of the razor blade 110, the blade housing 120, and the housing cover 130.

The razor blade 110 may include a base portion 111, a bent portion 112, and a cutting edge 113 (see FIG. 4).

The base 111 is sandwiched by razor blade supports 122 of the blade housing 120, which will be described later, so that the razor blade 110 is kept in the blade housing 120.

The bent portion 112 forms an obtuse angle from the base portion 111 and extends in a shaving direction. The shaving direction is a stroke direction of the razor cartridge 10 during shaving.

The cutting edge 113 is formed at an end of the bent portion 112, and extends from one end of the bent portion 112.

Although FIG. 4 shows an example in which three razor blades 110 are included in the razor cartridge 10, the number of razor blades 110 may vary depending on an embodiment.

The blade housing 120 forms a rear side of the razor cartridge 10 and receives the razor blades 110 in a longitudinal direction.

The blade housing 120 includes a housing frame 121 and a detachment part 127 and 128.

The housing frame 121 may include a housing upper frame 121a, a housing side frame 121b, a housing lower frame 121c, and a housing bridge frame 121d.

The housing frame 121 includes a plurality of rinsing holes 123 that are formed to pass through the housing frame 121 in a front-rear direction. The housing upper frame 121a, the housing side frame 121b, the housing lower frame 121c, and the housing bridge frame 121d may be distinguished by the plurality of rinsing holes 123.

The housing upper frame 121a and the housing lower frame 121c are formed to be substantially parallel to each other in a longitudinal direction. The housing side frame 121b may connect the housing upper frame 121a and the housing lower frame 121c, and the housing bridge frame 121d may be positioned between both housing lower frames to connect the housing upper frame 121a and the housing lower frame 121c.

The handle coupling part 124a and the contact surface 124b, which have been described above, are formed in a rear surface of the housing frame 121. For example, the handle coupling part 124a and the contact surface 124b may be formed at the rear surface of the housing frame 121.

A plurality of razor blade support parts 122 for respectively supporting the razor blades 110 is formed in a front surface of the housing frame 121. For example, referring to FIG. 4, the razor blade supports 122 may be formed to protrude forward from the housing bridge frame 121d and the housing side frame 121b. A razor blade support 122 protruding from the housing bridge frame 121d supports a central portion of a razor blade 110, and a razor blade support 122 protruding from the housing side frame 121b may support both sides of the razor blade 110.

As described above, the base portion 111 of the razor blade 110 is inserted between the razor blade supports 122 and is accommodated in the housing frame 121. The razor blade 110 is received in the longitudinal direction at the front of the plurality of rinsing holes 123. Foam, hair fragments, water, and the like generated during the shaving may be discharged through the plurality of rinsing holes 123, and washing water to wash the razor cartridge 10 after the shaving may be introduced through the plurality of rinsing holes 123.

A first side coupling part 125 and a second side coupling part 126 are respectively connected to the housing side frames 121b provided at both sides of the housing frame 121.

The first side coupling part 125 and the second side coupling part 126 are parts to be coupled to the housing cover 130 which will be described later. For example, referring to FIGS. 4 and 6, each of the first side coupling part 125 and the second side coupling part 126 may include a hook 125a and 126a for hook-coupling to the housing cover 130. A first hook 125a may be accommodated in a first hook receiving groove 136a formed in the housing cover 130 and a second hook 126a may accommodated in the second hook receiving groove 136b formed in the housing cover 130, so that the housing frame 121 and the housing cover 130 are coupled to each other.

The detachment part 127 and 128 may include a first side detachment part 127 extending from the first side coupling part 125 and a second side detachment part 128 extending from the second side coupling part 126.

The first side detachment part 127 and the second side detachment part 128 are parts to release the coupling between the first side coupling part 125 and the housing cover 130 and release the coupling between the second side coupling part 126 and the housing cover 130 by a user's operation, and for the safety of the user, the first side detachment part 127 and the second side detachment part 128 may be formed to extend in a different direction (e.g., the opposite direction) from a direction in which the cutting edge 113 faces. For example, referring to FIGS. 3 to 7, the first side detachment part 127 and the second side detachment part 128 may be formed to extend toward the rear of the razor cartridge 10.

The user may easily release the coupling between the first side coupling part 125 and the housing cover 130 and between the second side coupling part 126 and the housing cover 130 by a lever effect obtained by using the first side detachment part 127 and the second side detachment part 128.

For example, referring to FIGS. 4 and 6, when the user applies an external force toward the second side detachment part 128 to the first side detachment part 127, the force point of the lever effect is formed in the first side detachment part 127. The fulcrum of the lever effect is formed in a connection portion between the first side coupling portion 125 and the housing side frame 121b, and the action point of the lever effect is formed in hook-coupling between the first hook 125a and the first hook receiving groove 136a. Therefore, by the external force acting on the first side detachment part 127, the first side detachment part 127 and the first side coupling part 125 are elastically deformed, and the first hook 125a moves outward. It is separated from the first hook receiving groove (136a).

In order to reduce the external force acting on the first side detachment part 127 required to release the coupling between the first side coupling part 125 and the housing cover 130, a distance between the force point and the fulcrum may be longer than a distance between the acting point and the fulcrum. That is, the distance between the connecting portion of the first side coupling portion 125 and the housing side frame 121b and the end of the first side detachment part 127 may be longer than the distance between the connecting portion of the first side coupling portion 125 and the housing side frame 121b and the first hook (125a).

In addition, referring to FIGS. 4 and 6, when the user applies an external force toward the first side detachment part 127 to the second side detachment part 128, the power point of the lever effect is formed in the second side detachment part 128. The fulcrum of the lever effect is formed in a connection portion between the second side coupling portion 126 and the housing side frame 121b, and the action point of the lever effect is formed in hook-coupling between the second hook 126a and the second hook receiving groove 136b. Therefore, the second side detachment part 128 and the second side coupling portion 126 are elastically deformed by an external force acting on the second side detachment part 128, and accordingly the second hook 126a moves outward, thereby separated from the second hook receiving groove 136b.

In order to reduce the external force acting on the second side detachment part 128 required to release the coupling between the second side coupling portion 126 and the housing cover 130, a distance between the force point and the fulcrum may be longer than a distance between the acting point and the fulcrum. That is, a distance between the connecting portion between the second side coupling portion 126 and the housing side frame 121b and the end of the second side detachment part 128 may be longer than a distance between the connection portion between the second side coupling portion 126 and the housing side frame 121b and the second hook 126a.

Meanwhile, the housing cover 130 includes a window frame 132 forming a razor blade window 131.

The razor blade window 131 pass through the housing cover 130 in a front-rear direction so that at least a portion of the cutting edge 113 of the razor blade 110 accommodated in the blade housing 120 is exposed to the outside.

The window frame 132 may be formed to surround the razor blade window 131 and may include a window upper frame 132a, a window side frame 132c, and a window lower frame 132b. In this embodiment, a description is provided based on an example in which the window frame 132 surrounds all four corners of the razor blade window 131. However, in some embodiment, the window frame 132 may be configured to surround only a portion of the razor blade window 131. For example, at least one of the window upper frame 132a, the window side frame 132c, and the window lower frame 132b may be omitted.

The window upper frame 132a and the window lower frame 132b are formed to be substantially parallel to each other in the longitudinal direction. The window side frame 132c may connect both sides of the window upper frame 132a and the window lower frame 132b, and may form a substantially rectangular razor blade window 131 surrounded by the window frame 132.

The window upper frame 132a includes a hook 135 to be hook-coupled to the housing upper frame 121a. Referring to FIG. 5, the hook 135 may be formed to extend from the window upper frame 132a so as to protrude toward the razor blade window 131.

The housing cover 130 includes a detachment part 134. Referring to FIG. 4 and the like, the detachment part 134 may be formed to extend from the window upper frame 132a.

The detachable part 134 is a part to release the coupling between the window upper frame 132a and the housing upper frame 121a by a user's operation, and for the safety of the user, the detachable part 134 may be formed to extend from the window upper frame 132a in a different direction (e.g., the opposite direction) from a direction in which the cutting edge 113 faces. Referring to FIGS. 3 to 7, the detachment part 134 may be formed to extend toward the rear of the razor cartridge 10.

The user may easily release the coupling between the window upper frame 132a and the housing upper frame 121a by a lever effect that is obtained by using the detachment part 134.

For example, referring to FIG. 5, when the user applies an external force toward the front of the razor cartridge 10 to the detachment part 134, the force point of the lever effect is formed in the detachment part 134. The fulcrum of the lever effect is formed in the window upper frame 132a, and the action point of the lever effect is formed in hook-coupling between the hook 135 and the housing upper frame 121a. Therefore, the detachment part 134, the window upper frame 132a, and the housing upper frame 121a are elastically deformed by the external force acting on the detachment part 134, thereby decoupling between the hook 135 and the housing upper frame 121a.

In order to reduce the external force acting on the detachment part 134 required to release the coupling between the hook 135 and the housing upper frame 121a, a distance between the force point and the fulcrum may be longer than a distance between the action point and the fulcrum.

When the hooks 135 is configured as a pair of hooks spaced apart from each other, the detachment part 134 may be positioned between a pair of hooks 135. The detachment part 134 may be formed to extend from a central portion of the window upper frame 132a.

The first hook accommodating groove 136a and the second hook accommodating groove 136b are formed in the window side frame 132c forming both sides of the window frame 132. Through the hook-coupling between the first hook 125a and the first hook receiving groove 136a and the hook-coupling between the second hook 126a and the second hook receiving groove 136b, the window side frame 132c may be detachably coupled to the housing side frame 121b.

Referring to FIG. 4, a guard 133 including at least one pattern formed along the longitudinal direction around the razor blade window 131 may be provided in the front surface of the window frame 132. The pattern of the guard 133 may be embossed and/or engraved.

The guard 133 may be placed in close contact with the user's skin during the shaving to pull the skin so that the shaving can be done smoothly. To this end, the guard 133 may be provided at the front surface of the window lower frame 132b. In order to be help the razor 1 placed in further closer contact with the skin, the guard 133 may be formed of a rubber material and may be injection-molded at the front surface of the window lower frame 132b.

Although not shown, a lubricating band coated with a lubricating material may be provided at the front surface of the window upper frame 132a or the window lower frame 132b.

Although not shown, a comb member to align body hair during shaving may be provided at the front surface of the window upper frame 132a or the window lower frame 132b. The comb member may be formed to have at least one pattern extending approximately in a transverse direction.

Meanwhile, the shaving auxiliary member 140 may be interposed between the blade housing 120 and the housing cover 130 so that at least a portion of the shaving auxiliary member 140 is exposed on the front side of the razor blade window 131 or the housing cover 130.

Referring to FIG. 4, the shaving auxiliary member 140 may include a contact part 141 and a tail part 142.

The contact part 141 is exposed on the front side of the razor blade window 131 or the housing cover 130, and may be elongated in the longitudinal direction.

The tail part 142 may extend from the contact part 141 and may be interposed between the blade housing 120 and the housing cover 130.

For example, referring to FIG. 7, one side of the tail part 142 may be supported by the housing cover 130, and the other side of the tail part 142 may be supported by the blade housing 120.

More specifically, the window upper frame 132a and/or the window side frame 132c may include a first support 137 that supports one side of the tail part 142. The first support 137 may protrude from the window upper frame 132a toward the razor blade window 131 in order to press one side of the tail part 142. An end of the tail part 142 may be seated on the first support 137 protruding from the window upper frame 132a.

In addition, at least one of the housing upper frame 121a, the housing side frame 121b, and the housing bridge frame 121d may include a second support 129 that supports the other side of the tail part 142. The second support 129 may be provided to face the first support 137. In order to press the other side of the tail part 142, the second support 129 may be formed to protrude toward the first support 137 from at least one of the housing upper frame 121a, the housing side frame 121b, and the housing bridge frame 121d. The end of the tail part 142 may be seated on the second support 129.

The shaving auxiliary member 140 may include at least one of a guard, a comb member, and a lubricating band in the contact part 141.

As described above, one side of the tail part 142 of the shaving auxiliary member 140 is supported by the housing cover 130 and the other side thereof is supported by the blade housing 120, and thus, when the blade housing 120 is separated from the housing cover 130 as the coupling of the housing cover 130 and the blade housing 120 is released, the shaving auxiliary member 140 may be naturally separated from the housing cover 130 and the blade housing 120.

Hereinafter, a method of disassembling the razor cartridge 10 according to the present embodiment will be described.

In order to disassemble the razor cartridge 10, the user applies an external force to the first side detachment part 127 to release the hook-coupling between the first hook 125a and the first hook receiving groove 136a, and applies an external force to the second side detachment part 128 to release the hook-coupling between the second hook 126a and the second hook receiving groove 136b.

As a result, the housing side frame 121b and the window side frame 132c end up in a state decoupled from each other. However, in the housing upper frame 121a and the window upper frame 132a, the hook 135 and the housing upper frame 121a may remain hook-coupled.

Thereafter, the user releases the hook-coupling between the hook 135 and the housing upper frame 121a by applying an external force to the detachment part 134.

At the same time when the hook-coupling between the hook 135 and the housing upper frame 121a is released, the housing cover 130 is separated from the blade housing 120. As a result, the shaving auxiliary member 140 is also separated from the housing cover 130 and the blade housing 120.

The hook-coupling (first hook-coupling) between the hook 135 and the housing upper frame 121a may be released on the premise that the hook-coupling (third hook-coupling) between the second hook 126a and the second hook receiving groove 136b is released by applying an external force to the hook-coupling (second hook-coupling) between the first hook 125a and the first hook receiving groove 136a and to the second side detachment part 128. That is, even if a user applies an external force to the detachment part 134 to release the first hook-coupling in a state where the second hook-coupling and the third hook-coupling are not released, the housing cover 130 may not be separated from the blade housing 120 and even the first hook-coupling may not be released. This is because the second hook-coupling and the third hook-coupling are in a structure to maintain the coupling force with respect to a direction in which the housing cover 130 is separated from the blade housing 120 (a forward direction of the housing cover 130) (see FIG. 6).

The razor blade 110 may remain accommodated in the blade housing 120 or may be separated from the blade housing 120 due to an impact generated in the process of releasing the hook-coupling between the hook 135 and the housing upper frame 121a or due to the weight of the razor blade 110.

Even if the razor blade 110 remain accommodated in the blade housing 120, the user may be able to easily separate the razor blade 110 from the blade housing 120 because the housing cover 130 is already separated from the blade housing 120.

In the razor cartridge 10 according to the above-described embodiment, the user may be able to easily separate the housing cover 130 from the blade housing 120 by using the detachment parts 127, 128, and 134.

As a result, the user may separate the shaving auxiliary member 140 and the razor blade 110, which are accommodated in the housing cover 130 and the blade housing 120, from the housing cover 130 and the blade housing 120 and may discharge the shaving auxiliary member 140 and the razor blade 110 for recycling based on materials.

In addition, the shaving auxiliary member 140 may be automatically separated from the housing cover 130 and the blade housing 120 in response to the separation of the housing cover 130 and the blade housing 120, thereby improving convenience of disposal of the shaving auxiliary member 140.

In addition, the razor cartridge 10 according to the above-described embodiment is configured to completely separate the housing cover 130 and the blade housing 120 by releasing of the first coupling through the first side detachment part 127 and the second side detachment part 128 and by releasing of the second coupling through the detachment part 134. Therefore, even if the user releases any one of the aforementioned hook-couplings by applying an external force to any one of the first side detachment part 127, the second side detachment part 128, and the detachment part 134, the housing cover 130 and the blade housing 120 may not be completely separated, and thus, it is possible to prevent the razor cartridge 10 from being unintentionally disassembled.

Hereinafter, a razor blade separating device for separating the razor blade 110 from the blade housing 120 will be described.

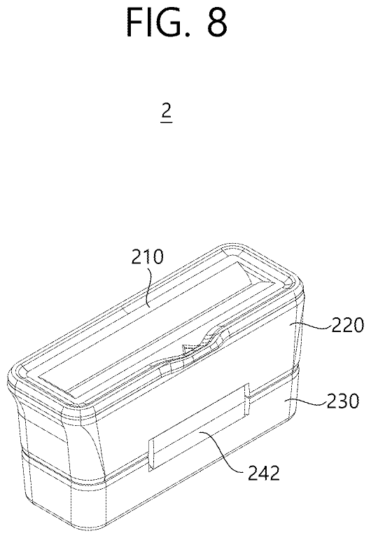

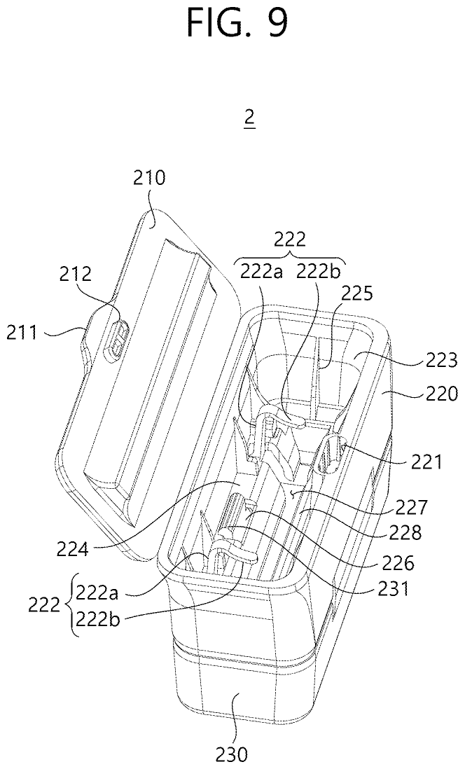

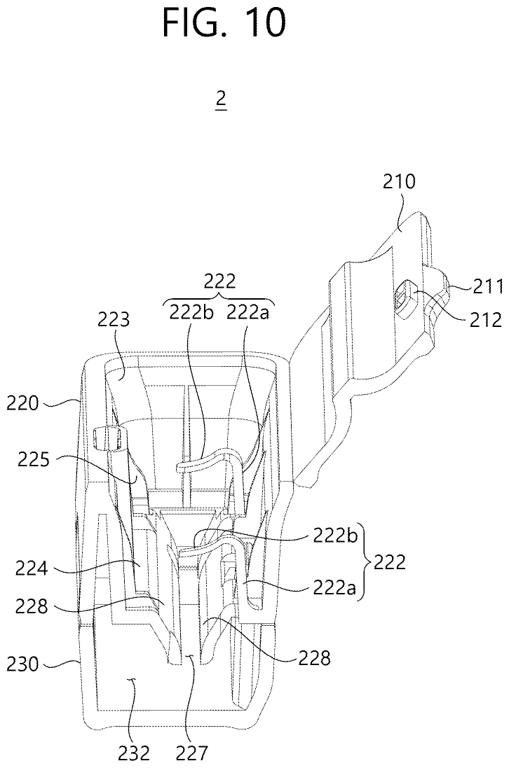

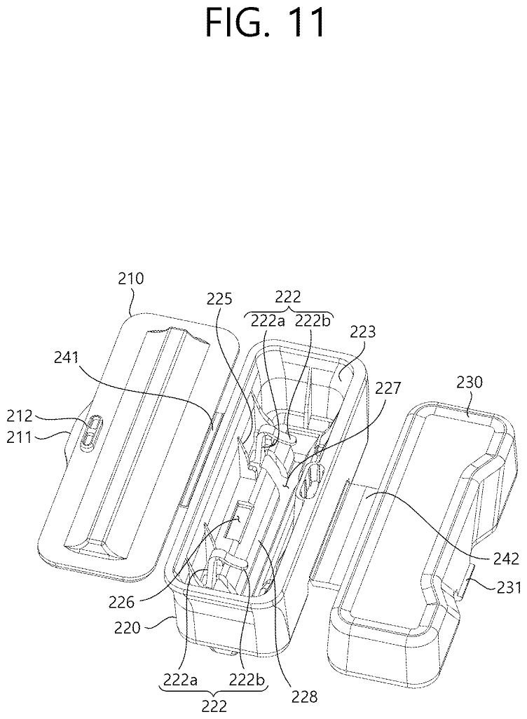

FIG. 8 is a perspective view showing a razor blade separating device 2 according to an embodiment of the present disclosure, FIG. 9 is a perspective view showing the razor blade separating device 2 shown in FIG. 8 with a cover 210 open, FIG. 10 is a cross-sectional perspective view showing the razor blade separating device 2 shown in FIG. 8 with the cover 210 open, and FIG. 11 is an exploded perspective view of the razor blade separating device 2 shown in FIG. 8.

Referring to FIG. 8, the razor blade separating device 2 according to an embodiment of the present disclosure includes the cover 210, a cartridge accommodating case 220, and a razor blade accommodating case 230.

The cover 210 and the cartridge accommodating case 220 may be rotatably connected to each other by a first hinge 241 (see FIG. 11). The cartridge accommodating case 220 and the razor blade accommodating case 230 may be rotatably connected to each other by a second hinge 242.

The first hinge 241 may be connected to one side of the upper end of the cartridge accommodating case 220, and the second hinge 242 may be connected to the other side of the lower end of the cartridge accommodating case 220. That is, the first hinge 241 and the second hinge 242 are located on opposite sides with respect to the cartridge receiving case 220.

In this case, compared to a case where the first hinge 241 and the second hinge 242 are formed in the same surface of the cartridge accommodating case 220, it is possible to prevent opening of a part not intended by a user.

For example, in the case where the first hinge 241 and the second hinge 242 are formed in the same surface of the cartridge accommodating case 220, when the user lifts a protrusion 211 of the cover 210 located on the opposite side of the first hinge 241 in order to open the cartridge accommodating case 220, the cover 210 and the cartridge accommodating case 220 may be unintentionally lifted together with respect to the second hinge 242 and accordingly the razor blade accommodating case 230 may be opened. As will be described later, the razor blade accommodating case 230 is a space in which the separated razor blade 110 is accommodated, and when the razor blade accommodating case 230 is unintentionally opened, any accident may happen due to the razor blade 110.

However, according to this embodiment, since the first hinge 241 and the second hinge 242 are located on opposite sides with respect to the cartridge accommodating case 220, the razor blade accommodating case 230 is prevented from being opened unintentionally, as described above.

Referring to FIGS. 9 and 11, the cover 210 includes the protrusion 211 protruding outward from at least one surface of the cover 210.

The protrusion 211 may be located on the opposite side of the first hinge 241 at the cover 210 and may be formed in the upper end of the cartridge receiving case 220. The protrusion 211 is to allow a user's finger to be easily caught, so that the user can easily lift the cover 210 from the cartridge accommodating case 220.

A locking protrusion 212 protruding toward the cartridge accommodating case 220 may be formed in a lower surface of the cover 210. The locking protrusion 212 is inserted into the locking protrusion receiving groove 221 formed in the upper end of the cartridge accommodating case 220, which will be described later, so that the cover 210 maintains the cartridge accommodating case 220 in a closed state.

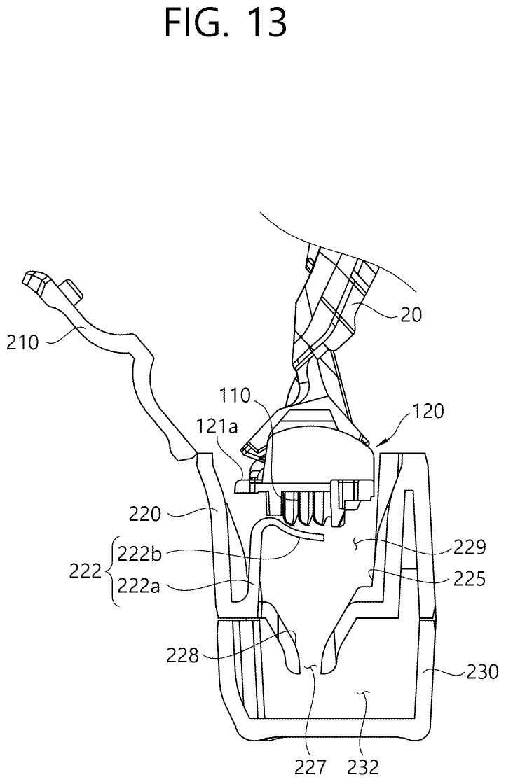

Referring to FIGS. 9 to 11, the cartridge accommodating case 220 is formed to have an open top, so that the top can be opened and closed by the cover 210. The cartridge accommodating case 220 forms a cartridge accommodating space 229 (see FIG. 13) surrounded by the sidewall 223. A razor blade outlet 227 to be opened downward so as to be connected to the cartridge receiving space 229 is formed in a bottom surface 224 of the cartridge receiving case 220.

A locking protrusion accommodating groove 221 to be fitted with the locking projection 212 is formed in the upper end of the cartridge receiving case 220. A tolerance between the locking projection 212 and the locking protrusion accommodating groove 221 may be a fit tolerance to an extent that can allow the user's finger to easily separate the locking protrusion 212 from the locking protrusion accommodating groove 221 while preventing the locking protrusion 212 from being separated from the locking protrusion receiving groove 221 due to the weight of the cover 210.

In another embodiment, a locking protrusion 212 may be formed in the upper end of the cartridge accommodating case 220, and a locking protrusion receiving groove 221 to accommodate the locking protrusion 212 may be formed in the cover 210.

The locking projection 212 and the locking protrusion accommodating groove 221 are merely examples for explaining the opening and closing structure between the cover 210 and the cartridge accommodating case 220, and the opening and closing structure between the cover 210 and the cartridge accommodating case 220 may vary.

The cartridge accommodating case 220 includes a razor blade separating arm 222 provided in the cartridge accommodating space 229.

The razor blade separating arm 222 includes a first arm 222a and a second arm 222b. The first arm 222a is formed to protrude from an inner surface of the side wall 223 or bottom surface 224 toward the cartridge receiving space 229, and the second arm 222b is elastically supported by the first arm 222a.

The razor blade separating arm 222 is configured to separate the razor blade 110, which is accommodated in the blade housing 120 entered the cartridge accommodating space 229, from the blade housing 120. More specific details will be described later.

The cartridge receiving case 220 includes a plurality of guide ribs 225 protruding from the inner surface of the side wall 223. The guide ribs 225 may be formed to protrude to increase in height in a direction toward the bottom surface 224. The guide rib 225 guide a position of the blade housing 120 entering into the cartridge accommodating space 229, so that relative positions of the razor blade separating arm 222 and the razor blade 110 accommodated in the blade housing are guided to intended positions.

A hook receiving groove 226 may be formed in the bottom surface 224 of the cartridge receiving case 220. The hook accommodating groove 226 is to constitute detachable hook-coupling with the hook 231 formed in the razor blade accommodating case 230 which will be described later.

In the bottom surface 224, a discharge inclined surface 228 forming a razor blade outlet 227 is formed. The discharge inclined surface 228 may form a downward inclined surface from the bottom surface 224 so that a horizontal cross-sectional area of the razor blade outlet 227 is gradually reduced in a vertical direction. Referring to FIG. 10, the discharge inclined surface 228 may include a pair of downward inclined surfaces facing each other, and the discharge inclined surface 228 may extend into a razor blade accommodating space 232 formed in the razor blade accommodating case 230, which will be described later.

Referring to FIGS. 9 to 11, the razor blade accommodating case 230 is formed to have an open top, so that the top can be opened and closed by the cartridge accommodating case 220. As described above, the upper end of the razor blade accommodating case 230 is connected to the cartridge accommodating case 220 by the second hinge 242, so that the top thereof is opened and closed by the cartridge accommodating case 220 with respect to the second hinge 242.

The razor blade accommodating case 230 may include a hook 231 that protrudes from at least one surface of the razor blade accommodating case 230.

The hook 231 may be located on the opposite side of the second hinge 242 at the razor blade accommodating case 230, and may be formed in the upper end of the razor blade accommodating case 230. The hook 231 is to constitute detachable hook-coupling with a hook accommodating groove 226 formed in the bottom surface 224 of the cartridge accommodating case 220.

The razor blade accommodating case 230 forms the razor blade accommodating space 232 by sidewalls and a bottom surface.

An open top of the razor blade accommodating case 230 may accommodate a portion of the discharge inclined surface 228, and a lower end of the discharge inclined surface 228 may extend to the inside of the razor blade accommodation space 232.

The razor blade accommodating case 230 accommodates the razor blade 110 fallen through the razor blade outlet 227 in the razor blade accommodating space 232. A user may release the hook-coupling between the cartridge housing case 220 and the razor blade accommodating case 230 and open the razor blade accommodating case 230 to recover the razor blade 110 accommodated in the razor blade accommodating space 232.

Hereinafter, a method of separating the razor blade 110 using the razor blade separating device 2 will be described.

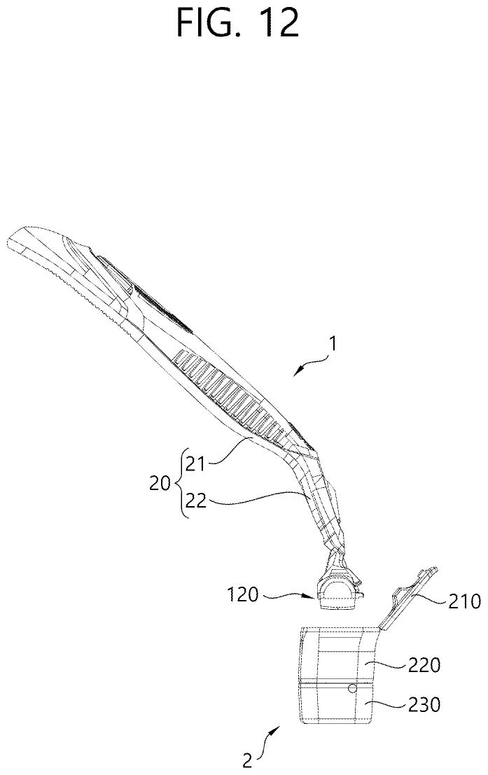

FIGS. 12 to 17 are views schematically showing a series of operations for explaining a method of separating the razor blade 110 using the razor blade separating device 2 according to an embodiment of the present disclosure.

Referring to FIGS. 12 and 13, after a user opens the cover 210 of the razor blade separating device 2 to open the top of the cartridge receiving case 220, the user allows the accommodated blade housing 120 with the razor blade 110 accommodated therein to enter into the cartridge accommodating space 229 while the housing cover 130 is separated. The blade housing 120 may be connected to the handle 20.

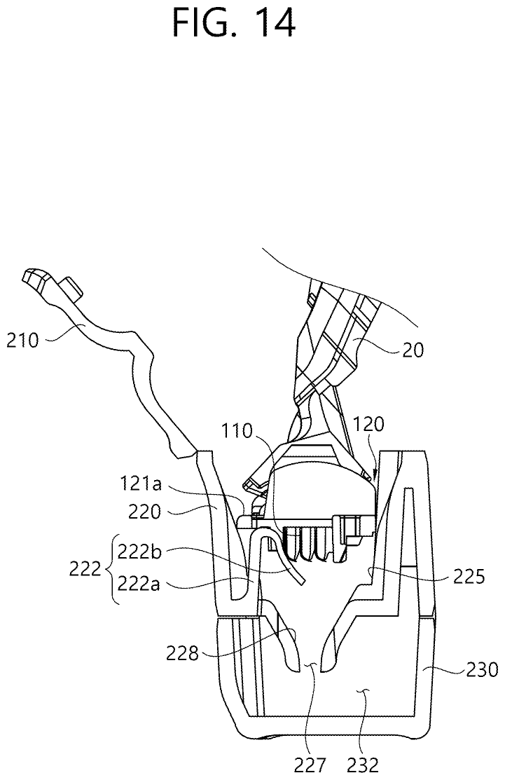

Referring to FIG. 14, as the user lowers the blade housing 120 to a lower portion of the cartridge receiving space 229, the blade housing 120 is guided by the guide ribs 225 to a position where the razor blade 110 is to be separated.

As the blade housing 120 is lowered as being guided by the guide ribs 225, the first arm 222a and the second arm 222b enters a space between the razor blade 110 and the cartridge accommodating case 220 or a space between the razor blade 110 and the guide ribs 225. Like the blade housing 120 according to this embodiment, the first arm 222a and the second arm 222b may enter a space between the housing upper frame 121a and the razor blade 110.

For example, referring to FIG. 4, the first arm 222a and the second arm 222b may enter into a space between the housing upper frame 121a and the razor blade 110 in the area of the rinsing holes 123 of the housing frame 121. In FIG. 4, the space into which the first arm 222a and the second arm 222b enter is closed by the upper frame 121a. However, in some embodiments, the entry space may be in the shape of a slit that is formed by removing a portion of the upper frame 121a. In this case, as the entry space between the first arm 222a and the second arm 222b is widened, the length of the second arm 222b may be increased.

Referring to FIG. 14, as the blade housing 120 is lowered, the second arm 222b may be placed in contact with a razor blade 110 positioned at the rearmost among the plurality of razor blades 110 in the shaving direction (that is, the direction in which the cutting edge 113 faces), and as the blade housing 120 is further lowered, the second arm 222b may be pressed downward by the rearmost razor blade 110 and may be elastically deformed to be folded toward the first arm 222a.

As the blade housing 120 is lowered, and the first arm 222a and the second arm 222b may pass through a space between the razor blades 110 and the housing upper frame 121a in a state in which the second arm 222b is folded toward the first arm 222a.

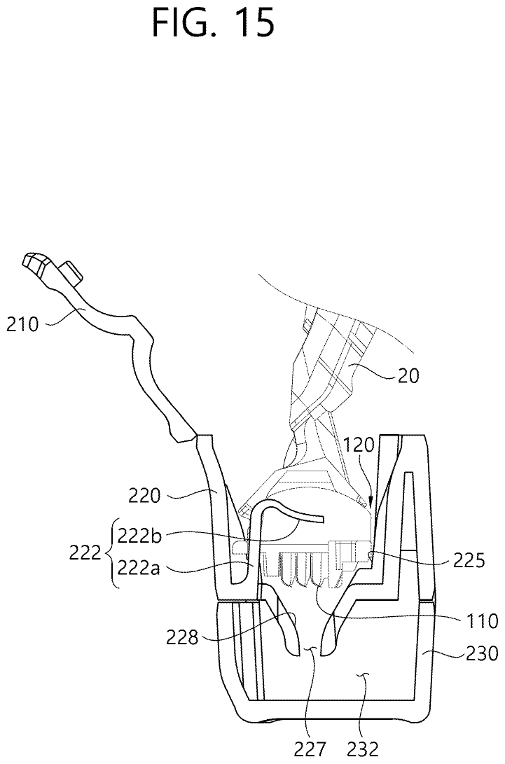

Referring to FIG. 15, when a free end of the second arm 222b passes through the space between the razor blades 110 and the cartridge receiving case 220 and then does not contact the razor blade 110 any longer, the second arm 222b returns to a free state (a state in which no external force acts on the second arm 222b). In this case, the first arm 222a passes through the blade housing 120, and the second arm 222b is positioned above the base portion 111 of the razor blade 110.

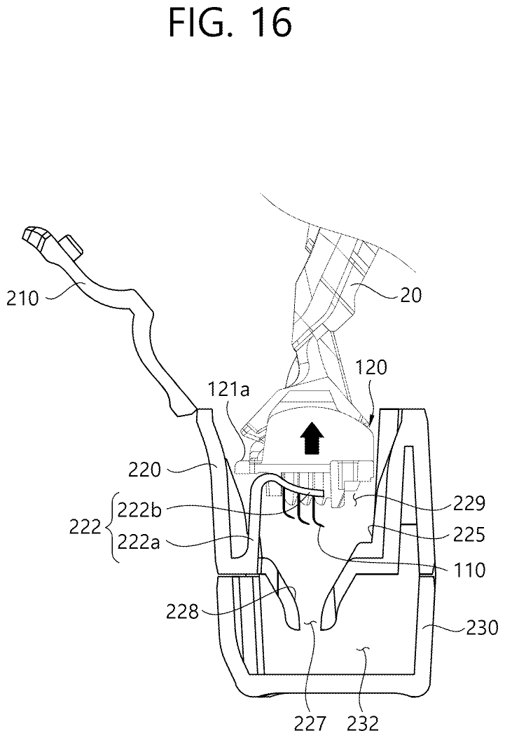

Referring to FIG. 16, after the second arm 222b returns to the free state so as to be positioned above the base portion 111 of the razor blade 110, the user raises the blade housing 120.

As the blade housing 120 is raised, the razor blade 110 is separated from the blade housing 120 in a state in which the second arm 222b supports the base portion 111 of the razor blade 110.

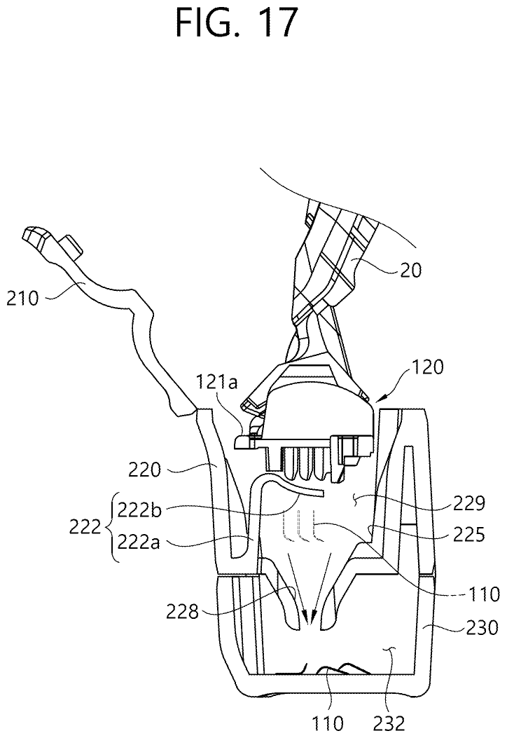

Referring to FIG. 17, the separated razor blade 110 passes through the razor blade outlet 227 and falls into the razor blade accommodating space 232 of the razor blade accommodating case 230. Since the razor blade outlet 227 is formed such that a horizontal cross-sectional area thereof is gradually reduced in the vertical direction by the discharge inclined surface 228, the separated razor blade 110 may be allowed to stably move into the razor blade receiving space 232. In addition, since the exit of the razor blade outlet 227 formed toward the razor blade accommodating space 232 is narrow, even if an impact or vibration is applied to the razor blade separating device 2, the razor blade 110 accommodated in the razor blade accommodating space 232 is less likely to move again to the cartridge receiving space 229 side through the razor blade outlet 227.

The razor blade 110 accommodated in the razor blade accommodating space 232 may be recovered by opening the razor blade accommodating case 230.

As described above, the razor blade separation device 2 according to an embodiment of the present disclosure allows a user to separate the razor blade 110 from the blade housing 120 simply by inserting and removing the blade housing 120 into and from the cartridge receiving case 220. Therefore, the user may be able to separate the razor blade 110 from the blade housing 120 even without touching the razor blade 110.

It will be evident to those skilled in the art that various modifications and changes may be made in the exemplary embodiments of the present disclosure without departing from the technical idea or the gist of the present disclosure. Therefore, it should be understood that the above-mentioned embodiments are not limiting but illustrative in all aspects. It should be appreciated that the scope of the present disclosure is defined by the following claims rather than the above-mentioned detailed descriptions and all modifications or alterations deduced from the meaning, the scope, and equivalences of the claims are to be construed as falling within the scope of the present disclosure.

What is claimed is:

1. A razor cartridge comprising:
at least one razor blade having a cutting edge formed therein;
a blade housing accommodating the at least one razor blade in a longitudinal direction; and
a housing cover comprising a razor blade window and a window frame, the razor blade window through which at least a portion of the cutting edge is exposed, and the window frame which is formed to surround at least a portion of the razor blade window and detachably coupled to the blade housing,
wherein at least one of the blade housing and the housing cover comprises a detachment part for separating at least a portion of the window frame from the housing cover by an external force.

2. The razor cartridge of claim 1, wherein the detachment part is formed to protrude in a direction different from a direction in which the cutting edge faces.

3. The razor cartridge of claim 1,
wherein the window frame comprises an upper frame detachably coupled to a top of the blade housing, and
wherein the detachment part is formed to extend from the upper frame.

4. The razor cartridge of claim 1,
wherein the window frame and at least a portion of the blade housing is detachably coupled to each other through hook-coupling,
wherein the detachment part is integrally formed with at least one of the window frame and the blade housing, and
wherein at least one of the window frame and the blade housing is deformed by an external force acting on the detachment part to release the hook-coupling.

5. The razor cartridge of claim 4,
wherein the detachment part induces deformation of at least one of the window frame and the blade housing by a lever effect,
wherein a force point of the lever effect is formed in the detachment part,
wherein fulcrum of the lever effect is formed in at least one of the window frame and the blade housing, and
wherein an action point of the lever effect is formed in the hook-coupling.

6. The razor cartridge of claim 5, wherein a distance between the force point and the fulcrum is longer than a distance between the action point and the fulcrum.

7. The razor cartridge of claim 1, further comprising:
a shaving auxiliary member having at least a portion interposed between the window frame and the blade housing and at least another portion exposed at a front surface of the housing cover,
wherein the shaving auxiliary member is separated from the housing cover and the blade housing as the window frame and the blade housing are separated.

8. The razor cartridge of claim 7,
wherein the window frame comprises a first support supporting one side of the shaving auxiliary member,
wherein the blade housing comprises a second support supporting the other side of the shaving auxiliary member, and
wherein the shaving auxiliary member is sandwiched by the first support and the second support.

9. The razor cartridge of claim 7, wherein the shaving auxiliary member comprises at least one of a lubricating band, a guard, and a comb member on a surface thereof.

10. The razor cartridge of claim 1, wherein at least one of the blade housing and the housing cover comprises a guard, at least a portion of which includes a pattern formed along the longitudinal direction around the razor blade window.

11. The razor cartridge of claim 1, wherein the detachment part is formed to extend from both sides of the blade housing along the longitudinal direction.

12. The razor cartridge of claim 1, wherein the detachment part comprises:
a first detachment part provided in the window frame; and
a second detachment part provided in the blade housing.

13. The razor cartridge of claim 12,
wherein the window frame and the blade housing are detachably coupled to each other by first hook-coupling, which is to be released by an external force acting on the first detachment part, and second hook-coupling, which is to be released by an external force acting on the second detachment part, and
wherein the window frame is separated from the blade housing based on that the first hook-coupling and the second hook-coupling are released.

14. The razor cartridge of claim 13, wherein the first hook-coupling is released on a premise that the second hook-coupling is released.
